(19) United States
(12) Patent Application Publication
(10) Pub. No.: US 2021/0182885 A1
(43) Pub. Date: Jun. 17, 2021

(54) PROMOTING COLLABORATIVE MARKETING THROUGH SOCIAL IOT FEED

(71) Applicant: International Business Machines Corporation, Armonk, NY (US)

(72) Inventors: Kristin E. McNeil, Charlotte, NC (US); Itai Gordon, Modiin (IL); Miriam Nizri, Jerusalem (IL); Radha Mohan De, Howrah (IN)

(21) Appl. No.: 16/709,956

(22) Filed: Dec. 11, 2019

(51) Int. Cl. G06Q 30/02; G06Q 50/00; G16Y 10/45

(52) U.S. Cl. CPC G06Q 30/0203; G16Y 10/45; G06Q 50/01

(57) ABSTRACT

In an approach for promoting collaborative marketing, a processor registers a user for a social IoT platform. A processor registers an IoT device associated with the registered user into the social IoT platform. A processor identifies social contacts of the registered user in the social IoT platform. A processor detects a plurality of IoT devices which are associated with the social contacts of the registered user. A processor monitors the IoT device associated with the registered user and the plurality of IoT devices associated with the social contacts of the registered user. A processor analyzes social IoT feed among the IoT device associated with the registered user and the plurality of IoT devices associated with the social contacts of the registered user. A processor recognizes a collaborative need for a plurality of registered users. A processor recommends a collaborative marketing plan based on the collaborative need.

### BACKGROUND

The present disclosure relates generally to the field of internet of things, and more particularly to promoting collaborative marketing through a social internet of things feed.

The internet of things (IoT) is a system of interrelated computing devices, mechanical and digital machines, objects, animals or people that are provided with unique identifiers and the ability to transfer data over a network without requiring human-to-human or human-to-computer interaction.

### SUMMARY

Aspects of an embodiment of the present disclosure disclose an approach for promoting collaborative marketing. A processor registers a user for a social IoT platform. A processor registers an IoT device associated with the registered user into the social IoT platform. A processor identifies social contacts of the registered user in the social IoT platform. A processor detects a plurality of IoT devices, in the social IoT platform, which are associated with the social contacts of the registered user. A processor monitors the IoT device associated with the registered user and the plurality of IoT devices associated with the social contacts of the registered user. A processor analyzes social IoT feed among the IoT device associated with the registered user and the plurality of IoT devices associated with the social contacts of the registered user. A processor recognizes a collaborative need for a plurality of registered users based on the analysis of the social IoT feed. A processor recommends a collaborative marketing plan based on the collaborative needs for the plurality of registered users.

### BRIEF DESCRIPTION OF THE DRAWINGS

FIG. 1 is a functional block diagram illustrating a collaborative marketing promotion environment, in accordance with an embodiment of the present disclosure.

FIG. 2 is a flowchart depicting operational steps of a collaborative marketing promotion module within a computing device of FIG. 1, in accordance with an embodiment of the present disclosure.

FIG. 3 is a block diagram of components of the computing device in FIG. 1, in accordance with an embodiment of the present disclosure.

### DETAILED DESCRIPTION

The present disclosure is directed to systems and methods for promoting collaborative marketing through a social IoT feed.

The IoT paradigm connects physical world and cyberspace via physical objects and facilitate the development of smart applications and infrastructures. A physical object is the basic constituent of IoT, often called as smart object, that interacts with other objects and possess the information processing abilities. The smart objects, when deployed in the real world, collect information from the surrounding environment. IoT has established a universe where humans are provided smart data services by the fusion of physical objects and information networks. With IoT, the internet has extended beyond humans to inanimate objects that are around us.

Social IoT may be defined as an IoT where things are capable of establishing social relationships with other objects autonomously. Through the social IoT paradigm, the capability of humans and devices to discover, select, and use objects with their services in IoT is augmented. Social IoT may convert smart objects to social objects. Social IoT may present an environment in which connected devices are given social meanings that can make them unique and distinguishable from other connected devices or things. In the context of social media, IoT may distribute some important benefits, including tracking the behavior of consumers in real-time and increasing awareness on the situation. This tracking can be very useful for businesses who rely on deep insights into consumer behavior to deliver the desired services.

On the internet, a feed is a data format used for providing users with frequently updated content. The feed may be a document (often WL-based) whose discrete content items include web links to the source of the content. News websites and blogs are common sources for web feeds, but feeds are also used to deliver structured information ranging from weather data to top-ten lists of hit music to search results. Feed content, like syndicated print newspaper features or broadcast programs, may be shared and republished by other websites. A typical scenario of web-feed use might involve the following: a content provider publishes a feed link on the content provider's website which end users can register with an aggregator program running on their own machine(s).

An embodiments of the present disclosure discloses a system that may promote collaborative marketing by detecting the need for products from social network member interactions and discussions about products and services through a social IoT feed in a social IoT platform. An embodiment of the present disclosure recognizes some need of the products for more than one social network member, who are connected with one another as contacts. An embodiment of the present disclosure may propose a promotional offer for a user to buy multiple products.

In an example, in the retail space, retailers typically provide a discount to consumers for buying a product in larger quantities. However, a single consumer usually cannot consume, or otherwise may not have a need for, such large quantities. Consumers typically have friends and family members who may have similar shopping habits to them. Thus, consumers can potentially join together to purchase an item in larger quantities, and be able to receive such a discount. In a example, if a customer plans to buy a freezer for his or her home, one of his or her friends might be interested in buying a freezer for their home as well. In another example, when someone wants to buy a pack of five soaps, his or her friend may want to buy shampoo. In this example, a company could offer a pack of five soaps with a shampoo in a discounted price. In these examples, the consumers can join together to purchase an item in larger quantities and might ask and receive a discount from the retailers. In another example, a vendor may provide a deal in response to finding out that multiple people want something. The customers may recognize the deal exists and find people who could go in together to take advantage of that existing deal.

An embodiment of the present disclosure may intelligently analyze a feed from social IoT, including devices and other interactions, to find suitable products for more than one social network member. The analysis can lead to the creation of a discounted marketing plan for certain products, to push sales among some connected social members, as a win-win offer for the consumers and the vendors.

An embodiment of the present disclosure recognizes that a recent trend in social IoT networking brings inanimate objects to communicate among the social network members to find solutions to their problems. An embodiment of the present disclosure discloses promoting a collaborative marketing plan to the users by analyzing a social IoT feed among the users' devices, which contains an offer for a set of products that may be required by more than one social network user member to fulfill the need. An embodiment of the present disclosure may enable vendors 130 to push a product recommendation, for collaborative marketing, to the consumers. An embodiment of the present disclosure may use social IoT devices to find two or more prospective and socially connected consumers who may need a set of products. In an example, a company may have many products for different uses. The company might want to promote a package deal based on the knowledge that a customer and the customers' friends may have a dishwasher and washer machine. The information may help the company sell more products together for the customer and the customers' friends. If shipping is involved, then it may be cheaper to send both products together.

In an example, a user's refrigerator filter may need to be replaced immediately while the user's friend's refrigerator filter needs to be replaced in about ten days. A company could send the user a marketing promotion for four filters, for example, two filters for the user and two filters for the user's friend. In another example, co-workers are connected to one another on social media and work at the same location. The seller could send a merchandise to the office (one location) and the two co-workers could pick up the item at the office, with a discounted price, by saving the shipping cost.

The present disclosure discloses analyzing a social IoT feed to recommend products for collaborative marketing among two or more social contacts who frequently connect with each other. The present disclosure discloses analyzing the social IoT feed to connect multiple social network members to let the social network members make a marketing plan with discounted price against some product offers based on a common need of the connected social network members.

An embodiment of the present disclosure may register a user for a subscription service in a social IoT platform. An embodiment of the present disclosure may allow the user to register one or more IoT embedded devices into the social IoT platform through an interface available in the system for the user. An embodiment of the present disclosure may find, in the social IoT platform, correlated IoT devices which are associated with the registered user and social contacts of the registered user. An embodiment of the present disclosure may track the correlated IoTs and the associated social network information to find closely connected contacts. An embodiment of the present disclosure may identify IoT devices in the social IoT platform that may be similar or correlated by some vendor brands that the users are interested. The identification may be based on available marketing campaign inputs and IoTs found in the social network. An embodiment of the present disclosure may compile collected information to find common needs for more than one registered member and to offer some discount and/or other marketing offer to entice the registered member with a collaborative marketing plan. An embodiment of the present disclosure may recognize a location of IoT device in the social IoT platform. An embodiment of the present disclosure may recognize that the marketing campaign price may need to change because, for example, shipping to more than one location may be more expensive. An embodiment of the present disclosure may analyze cause of a similarity, e.g., similar hobbies, among the user and the user's social contacts. From the similarity, an embodiment of the present disclosure may find how many other people in the social IoT platform can have a same or similar reason to like the same set of products. From the list, an embodiment of the present disclosure may create a scope for a collaborative marketing plan.

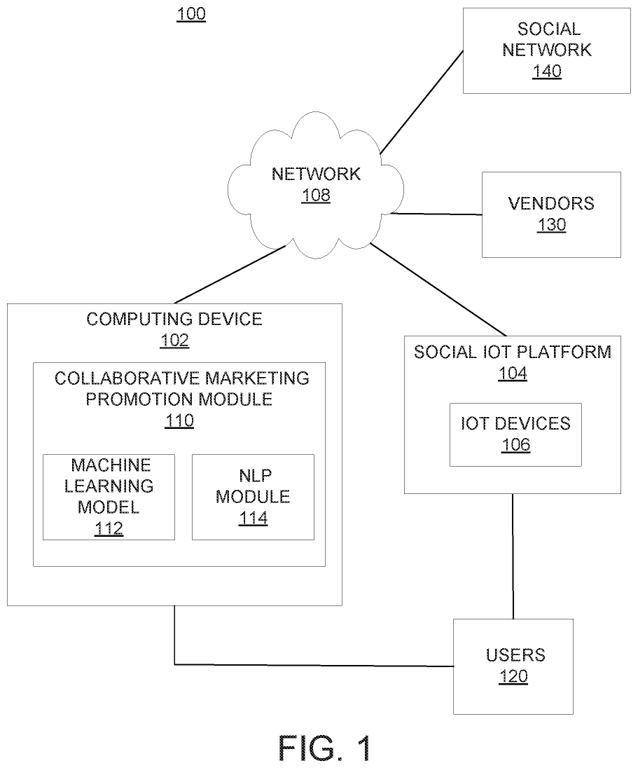

The present disclosure will now be described in detail with reference to the Figures. FIG. 1 is a functional block diagram illustrating a collaborative marketing promotion environment, generally designated 100, in accordance with an embodiment of the present disclosure.

In the depicted embodiment, collaborative marketing promotion environment 100 includes computing device 102, social IoT platform 104, network 108, users 120, vendors 130, and social network 140. Social network 140 is generally a network of social interactions and personal relationships. In an example, social network 140 is an online service or site through which people create and maintain interpersonal relationships. For example, social network 140 may be a dedicated website or other application which enables users 120 to communicate with each other by, for example, sharing or posting information, comments, messages, images, videos, etc. Social network 140 may be accessed through a communication network such as network 108.

In the depicted embodiment, social IoT platform 104 includes IoT devices 106. In general, IoT devices 106 are devices that connect to a network (e.g., network 108) and may have the ability to transmit data. IoT devices 106 may be devices uniquely identifiable through social IoT platform 104. IoT devices 106 may be a piece of hardware with a sensor that transmits data from one place to another over network 108. Types of IoT devices 106 may include wireless sensors, software, actuators, and devices. IoT devices 106 may be physical devices that are connected to the internet, collecting and sharing data. IoT devices 106 may be devices which have support for internet connectivity and are able to interact with the other devices over the internet and grant remote access to a user for managing the device. IoT devices 106 may be, for example, smart mobiles, smart refrigerators, smart watches, smart fire alarm, smart door lock, smart bicycle, medical sensors, fitness trackers, and smart security system. Social IoT platform 104 is a platform that may facilitate the communication, data flow, device management, and the functionality of applications among IoT devices 106. Social IoT platform 104 may provide the support software and applications for IoT devices 106. Social IoT platform 104 may connect IoT devices 106. Social IoT platform 104 may handle different hardware and software communication protocols and provide security and authentication for IoT devices 106 and users 120. Social IoT platform 104 may collect data that IoT devices 106 and users 120 gather. Social IoT platform 104 may be accessed through a communication network such as network 108. In one embodiment, social IoT platform 104 may be integrated with social network 140 or other suitable network services.

In one or more embodiments, social IoT platform 104 may provide the convergence of IoT and social networking paradigms for the creation of social networks in which things are nodes that establish social links. Social IoT platform 104 may support the interconnection of IoT devices 106, users 120, vendors 130 and other suitable participants that can benefit from involving in network 108. Social IoT platform 104 may be empowered by the interconnectivity and friend-of-a-friend feature and can support the integration of IoT devices 106 into interactions and conversations with users 120, vendors 130, and other suitable participants in network 108.

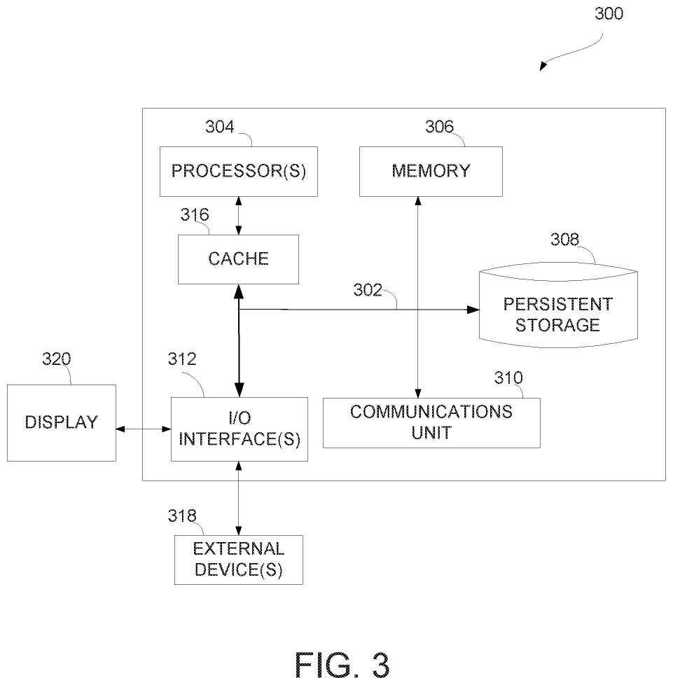

In various embodiments of the present disclosure, computing device 102 can be a laptop computer, a tablet computer, a netbook computer, a personal computer (PC), a desktop computer, a mobile phone, a smartphone, a smart watch, a wearable computing device, a personal digital assistant (PDA), or a server. In another embodiment, computing device 102 represents a computing system utilizing clustered computers and components to act as a single pool of seamless resources. In other embodiments, computing device 102 may represent a server computing system utilizing multiple computers as a server system, such as in a cloud computing environment. In general, computing device 102 can be any computing device or a combination of devices with access to collaborative marketing promotion module 110 and network 108 and is capable of processing program instructions and executing collaborative marketing promotion module 110, in accordance with an embodiment of the present disclosure. Computing device 102 may include internal and external hardware components, as depicted and described in further detail with respect to FIG. 3.

Further, in the depicted embodiment, computing device 102 includes collaborative marketing promotion module 110. In the depicted embodiment, collaborative marketing promotion module 110 is located on computing device 102. However, in other embodiments, collaborative marketing promotion module 110 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between computing device 102 and collaborative marketing promotion module 110, in accordance with a desired embodiment of the disclosure.

In the depicted embodiment, collaborative marketing promotion module 110 includes machine learning model 112 and natural language processing (NLP) module 114. In the depicted embodiment, machine learning model 112 and NLP module 114 are located on collaborative marketing promotion module 110 and computing device 102. However, in other embodiments, machine learning model 112 and natural language processing (NLP) module 114 may be located externally and accessed through a communication network such as network 108.

In one or more embodiments, machine learning model 112 includes a wide variety of algorithms and methodologies that may be used by computer device 102 and collaborative marketing promotion module 110. Machine learning model 112 may be trained under supervision, by learning from examples and feedback, or in unsupervised mode. Machine learning model 112 may include neural networks, deep learning, support vector machines, decision trees, self-organizing maps, case-based reasoning, instance-based learning, hidden Markov models, and regression techniques. In another example, machine learning model 112 is a deep learning model that employs a multi-layer hierarchical neural network architecture and an end-to-end approach to training where machine learning model 112 is trained by a set of input data and desired output with learning happening in the intermediate layers. Machine learning model 112 may learn to adjust weights of the interconnections in the training process.

In one or more embodiments, NLP module 114 is a module of augmented intelligence or artificial intelligence concerned with analyzing, understanding, and generating natural human languages. NLP module 114 may be used by collaborative marketing promotion module 110 to analyze and understand texts, languages and information from users 120, social IoT platform 104, IoT devices 106, vendors 130, and social network 140.

In one or more embodiments, collaborative marketing promotion module 110 is configured to register users 120 for social IoT platform 104. Users 120 can disable this feature or have to opt in to have their information be obtained. Users 120 are in control of what type of information is going to be collected and aware of how that information is going to be used. Collaborative marketing promotion module 110 may register users 120 for a subscription service in social IoT platform 104. Collaborative marketing promotion module 110 may register users 120 to join and use social IoT platform 104 though a user interface available in social IoT platform 104. Collaborative marketing promotion module 110 may collect information to set up a user profile for each registered user in social IoT platform 104. Collaborative marketing promotion module 110 may assign a user name with login information for each registered user. Users 120 are in control of what type of information is going to be collected and aware of how that information is going to be used. Users 120 are given options to decide to register or not. Users 120 can withdraw from social IoT platform 104 if desired.

In one or more embodiments, collaborative marketing promotion module 110 may register one or more IoT devices 106 associated with a registered user into social IoT platform 104 per the request of the registered user. In an example, collaborative marketing promotion module 110 may allow the registered user to register one or more IoT devices 106 into social IoT platform 104 through an interface available in computing device 102. In another example, collaborative marketing promotion module 110 may allow users 120 to register associated IoT devices 106 to join and use social IoT platform 104 though a user interface available in social IoT platform 104.

In one or more embodiments, collaborative marketing promotion module 110 is configured to identify social contacts of registered users 120 in social IoT platform 104. In another example, collaborative marketing promotion module 110 may identify social contacts of users 120 in social network 140. Collaborative marketing promotion module 110 may detect IoT devices 106, in social IoT platform 104, which are associated with the social contacts of the registered users. Collaborative marketing promotion module 110 may monitor IoT devices 106 associated with the registered users 120 and the social contacts of users 120. Collaborative marketing promotion module 110 may track social network information among IoT devices 106 associated with registered users 120 and the social contacts of registered user 120. Collaborative marketing promotion module 110 may find, in social IoT platform 104, correlated IoT devices 106 which are associated with registered users and the social contacts of registered users 120. Collaborative marketing promotion module 110 may track the correlated IoT devices 106 and the associated social network information to find closely connected contacts of users 120. Collaborative marketing promotion module 110 may identify IoT devices 106 in social IoT platform 104 that may be similar or correlated by some brands from vendors 130 that the users are interested. In an example, the identification of product brands from vendors 130 may be based on available marketing campaign inputs found in social network 140. In another example, the identification of product brands from vendors 130 may be based on available marketing campaign inputs and IoT devices 106 in social IoT platform 104. Collaborative marketing promotion module 110 may allow vendors 130 to check which of their products can fit with what products. Collaborative marketing promotion module 110 may allow vendors to link with other complimentary products from vendors 130.

In one or more embodiments, collaborative marketing promotion module 110 is configured to analyze social IoT feed among IoT devices 106 associated with registered users 120 and the social contacts of registered users 120. Users 120 can disable this feature or have to opt in to have their information be obtained. Users 120 are in control of what type of information is going to be collected and aware of how that information is going to be used. The social IoT feed may include interactions and conversations associated with IoT devices 106 and registered users 120. Collaborative marketing promotion module 110 may analyze the social IoT feed among IoT devices 106 by using machine learning model 112 and NLP module 114. For example, collaborative marketing promotion module 110 may analyze the interactions and conversations using machine learning model 112. Collaborative marketing promotion module 110 may analyze the conversations using NLP module 114. Collaborative marketing promotion module 110 may intelligently analyze feed from social IoT, including devices and other interactions to find suitable products for two or more users 120. The analysis can lead to create a discounted marketing plan for certain products to push sales among some connected social members (e.g., users 120) as a win-win offer for users 120 and vendors 130.

In one or more embodiments, collaborative marketing promotion module 110 may recognize collaborative needs for two or more registered users 120 based on the analysis of the social IoT feed. Collaborative marketing promotion module 110 may promote collaborative marketing by detecting the need for products from interactions and discussions about products and services through social IoT feed in social IoT platform 104. Collaborative marketing promotion module 110 may recognize some need of the products for two or more social network members, who are connected as contacts. Collaborative marketing promotion module 110 may propose a promotional offer to buy a product for a multiple product offer. Collaborative marketing promotion module 110 may promote a collaborative marketing plan to users 120 by analyzing social IoT feed among the users' IoT devices 106, which contains an offer for a set of products that may be required for more than one social network user member to fulfill the need. In an example, collaborative marketing promotion module 110 may enable vendors 130 to push a product recommendation for collaborative marketing to users 120. Collaborative marketing promotion module 110 may use social media tips available from social network 140 to find two or more prospective and socially connected users 120 who may need a set of products. In another hypothetical example, vendors 130 may have many products for different usages. Vendors 130 might want to promote a package deal based on the knowledge that users 120 and social contacts of users 120 may have, for example, a dishwasher and washer machine. The information may help vendors 130 to make a plan to sell more products together for users 120 and social contacts of users 120, if shipping is involved, then it is cheaper to send both together.

In one or more embodiments, collaborative marketing promotion module 110 may recommend a collaborative marketing plan based on the collaborative needs for the two or more registered users 120. Collaborative marketing promotion module 110 may identify two or more IoT devices 106 in social IoT platform 104 that are correlated by a product, based on marketing inputs from vendor 130. Collaborative marketing promotion module 110 may consider location information of the two or more registered users 120 for recommending the collaborative marketing plan. In an example, in the retail space, vendors 130 may typically provide a discount to a consumer (e.g., one of users 120) for buying a product in larger quantities. However, the consumer may not consume large quantities. The consumer may have friends and family members who may have similar shopping habits to the consumer. When the consumer and the friends and family members of the consumer can join together to purchase an item in larger quantities, the consumers (e.g., users 120) might receive a discount. Vendors 130 also benefit from the purchase since the retails are making a higher sale than if only one person would purchase. In another example, if a customer plans to buy a freezer for his or her home, one of his or her friends might be interested in buying a freezer for their home as well. In another example, when someone wants to buy a pack of five soaps, his or her friend may want to buy shampoo. In the example, vendors 130 could offer a pack of five soaps with a shampoo in a discounted price. In these examples, the consumers (e.g., users) can join together to purchase an item in larger quantities and might ask and receive a discount from vendors 130.

In one or more embodiments, collaborative marketing promotion module 110 may analyze a social IoT feed to recommend products for collaborative marketing among two or more social contacts who frequently connect with each other. Collaborative marketing promotion module 110 analyze the social IoT feed to connect multiple social network members (e.g., users 120) to let users 120 make a marketing plan with discounted price against some product offers based on a common need of the connected social network members (e.g., users 120). Collaborative marketing promotion module 110 may compile information collected to find common needs for more than one registered user 120 to offer some discount and other marketing offers to entice users 120 for a collaborative marketing plan. Collaborative marketing promotion module 110 may recognize location of IoT devices 106 in social IoT platform 104. Collaborative marketing promotion module 110 may recognize that the marketing campaign price may need to change since shipping to more than one location may be more expensive. Collaborative marketing promotion module 110 may recognize broader locations for IoT devices 106 associated with users 120. Collaborative marketing promotion module 110 may analyze cause of a likeness among users 120 and the social contacts of users. From the likeness, collaborative marketing promotion module 110 may find how many other users 120 in social IoT platform 104 can have a same or similar reason to like the same set of products, which users 120 do not possess yet. From the list, collaborative marketing promotion module 110 may create a scope for the collaborative marketing plan.

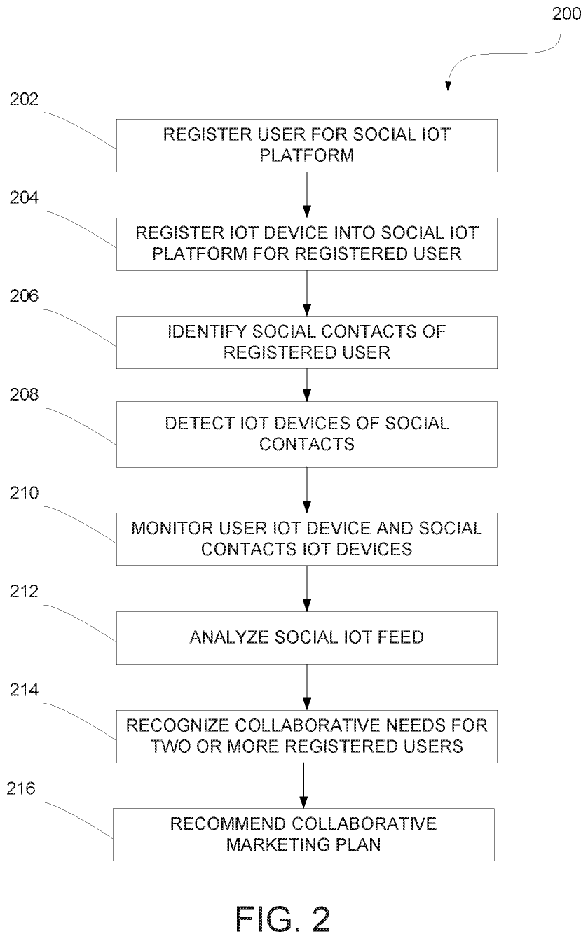

FIG. 2 is a flowchart 200 depicting operational steps of collaborative marketing promotion module 110 in accordance with an embodiment of the present disclosure.

Collaborative marketing promotion module 110 operates to register users 120 for social IoT platform 104. Collaborative marketing promotion module 110 operates to register IoT devices associated with registered users 120 into social IoT platform 104. Collaborative marketing promotion module 110 operates to identify social contacts of registered users 120 in social IoT platform 104. Collaborative marketing promotion module 110 operates to detect a plurality of IoT devices 106, in social IoT platform 104, which are associated with the social contacts of registered users 120. Collaborative marketing promotion module 110 operates to monitor IoT devices 106 associated with registered users 120 and the plurality of IoT devices 106 associated with the social contacts of registered users 120. Collaborative marketing promotion module 110 operates to analyze social IoT feed among IoT devices 106 associated with registered users and associated with the social contacts of registered users 120. Collaborative marketing promotion module 110 operates to recognize collaborative needs for two or more registered users 120 based on the analysis of the social IoT feed. Collaborative marketing promotion module 110 operates to recommend a collaborative marketing plan based on the collaborative needs for the two or more registered users 120.

In step 202, collaborative marketing promotion module 110 registers users 120 for social IoT platform 104. Collaborative marketing promotion module 110 may register users 120 for a subscription service in social IoT platform 104. Collaborative marketing promotion module 110 may register users 120 to join and use social IoT platform 104 though a user interface available in social IoT platform 104. Collaborative marketing promotion module 110 may collect information to set up a user profile for each registered user in social IoT platform 104. Collaborative marketing promotion module 110 may assign a user name with login information for each registered user. Users 120 are in control of what type of information is going to be collected and aware of how that information is going to be used. Users 120 are given options to decide to register or not. Users 120 can withdraw from social IoT platform 104 if desired.

In step 204, collaborative marketing promotion module 110 registers one or more IoT devices 106 associated with a registered user into social IoT platform 104 per the request of the registered user. In an example, collaborative marketing promotion module 110 may allow the registered user to register one or more IoT devices 106 into social IoT platform 104 through an interface available in computing device 102. In another example, collaborative marketing promotion module 110 may allow users 120 to register associated IoT devices 106 to join and use social IoT platform 104 though a user interface available in social IoT platform 104.

In step 206, collaborative marketing promotion module 110 identifies social contacts of registered users 120 in social IoT platform 104. Collaborative marketing promotion module 110 may identify social contacts of registered users 120 through profiles of registered users 120. Collaborative marketing promotion module 110 may identify social contacts of registered users 120 when registered users 120 and social contacts of registered users 120 post comments and communicate each other in social IoT platform 104. In another example, collaborative marketing promotion module 110 may identify social contacts of users 120 in social network 140. Collaborative marketing promotion module 110 may identify social contacts of registered users 120 through profiles of registered users 120. Collaborative marketing promotion module 110 may identify social contacts of registered users 120 when registered users 120 and social contacts of registered users 120 post comments and communicate each other in social network 140.

In step 208, collaborative marketing promotion module 110 detects IoT devices 106 in social IoT platform 104. In an example, IoT devices 106 are registered with registered users 120. In another example, IoT devices 106 are associated with the social contacts of registered users 120.

In step 210, collaborative marketing promotion module 110 monitors IoT devices 106 associated with registered users 120 and the social contacts of registered users 120. Collaborative marketing promotion module 110 may track social network information among IoT devices 106 associated with registered user 120 and the social contacts of registered users 120. Collaborative marketing promotion module 110 may find, in social IoT platform 104, correlated IoT devices 106 which are associated with registered users 120 and the social contacts of registered users 120. Collaborative marketing promotion module 110 may track the correlated IoT devices 106 and the associated social network information to find closely connected contacts of users 120. Collaborative marketing promotion module 110 may identify IoT devices 106 in social IoT platform 104 that may be similar or correlated by some brands from vendors 130 that the users are interested. In an example, the identification of product brands from vendors 130 may be based on available marketing campaign inputs found in social network 140. In another example, the identification of product brands from vendors 130 may be based on available marketing campaign inputs and IoT devices 106 in social IoT platform 104. Collaborative marketing promotion module 110 may allow vendors 130 to check which of their products can fit with what products. Collaborative marketing promotion module 110 may allow vendors to link with other complimentary products from vendors 130.

In step 212, collaborative marketing promotion module 110 analyzes social IoT feed among IoT devices 106 associated with registered users 120 and the social contacts of registered users 120. The social IoT feed may include interactions and conversations associated with IoT devices 106 and registered users 120. Collaborative marketing promotion module 110 may analyze the social IoT feed among IoT devices 106 by using machine learning model 112 and NLP module 114. For example, collaborative marketing promotion module 110 may analyze the interactions and conversations using machine learning model 112. In another example, collaborative marketing promotion module 110 may analyze the conversations using NLP module 114. For example, when registered users 120 post comments and share information in social IoT platform 104, collaborative marketing promotion module 110 may capture and understand the comments and information. In an example, when some registered users 120 share something like a washer and a need for a part, collaborative marketing promotion module 110 may recognize that a part needs to be replaced and send a notification of the part need for other registered users 120 that may have a similar need.

In step 214, collaborative marketing promotion module 110 recognizes collaborative needs for two or more registered users 120 based on the analysis of the social IoT feed. Collaborative marketing promotion module 110 may promote collaborative marketing by detecting the need for products from interactions and discussions about products and services through social IoT feed in social IoT platform 104. Collaborative marketing promotion module 110 may recognize need of the products for two or more social network members (e.g., users 120), who are connected as contacts. Collaborative marketing promotion module 110 may propose a promotional offer from vendors 130 for users 120 to buy a product. Collaborative marketing promotion module 110 may promote a collaborative marketing plan to users 120 by analyzing social IoT feed among the users' IoT devices 106, which contains an offer for a set of products that may be required for more than one social network user member to fulfill the need. In an example, collaborative marketing promotion module 110 may enable vendors 130 to push a product recommendation for collaborative marketing to users 120. Collaborative marketing promotion module 110 may use social media tips available from social network 140 to find two or more prospective and socially connected users 120 who may need a set of products. In another example, vendors 130 may have many products for different usages. Vendors 130 might want to promote a package deal based on the knowledge that users 120 and social contacts of users 120 may have, for example, a dishwasher and washer machine. The information may help vendors 130 to make a plan to sell more products together for users 120 and social contacts of users 120, if shipping is involved, then it is cheaper to send both together.

In step 216, collaborative marketing promotion module 110 recommends a collaborative marketing plan based on the collaborative needs for two or more registered users 120. Collaborative marketing promotion module 110 may identify two or more IoT devices 106 in social IoT platform 104 that are correlated by a product, based on marketing inputs from vendor 130. Collaborative marketing promotion module 110 may consider location information of the two or more registered users 120 for recommending the collaborative marketing plan. In an example, in the retail space, vendors 130 may provide a discount to a consumer (e.g., one of users 120) for buying a product in larger quantities. However, the consumer may not consume large quantities. The consumer may have friends and family members who may have similar shopping habits as the consumer. When the consumer and the friends or family members of the consumer can join together to purchase an item in larger quantities, the consumers (e.g., users 120) might receive a discount. Vendors 130 also benefit from the purchase since the retails are making a higher sale than if only one person would purchase. In another example, if a customer plans to buy a freezer for his or her home, one of his or her friends might be interested in buying a freezer for their home as well. In another example, when someone wants to buy a pack of five soaps, his or her friend may want to buy shampoo. In the example, vendors 130 could offer a pack of five soaps with a shampoo in a discounted price. In these examples, the consumers (e.g., users) can join together to purchase an item in larger quantities and might ask and receive a discount from vendors 130.

FIG. 3 depicts a block diagram 300 of components of computing device 102 in accordance with an illustrative embodiment of the present disclosure. It should be appreciated that FIG. 3 provides only an illustration of one implementation and does not imply any limitations with regard to the environments in which different embodiments may be implemented. Many modifications to the depicted environment may be made.

Computing device 102 may include communications fabric 302, which provides communications between cache 316, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses or a crossbar switch.

Memory 306 and persistent storage 308 are computer readable storage media. In this embodiment, memory 306 includes random access memory (RAM). In general, memory 306 can include any suitable volatile or non-volatile computer readable storage media. Cache 316 is a fast memory that enhances the performance of computer processor(s) 304 by holding recently accessed data, and data near accessed data, from memory 306.

Collaborative marketing promotion module 110 may be stored in persistent storage 308 and in memory 306 for execution by one or more of the respective computer processors 304 via cache 316. In an embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 includes one or more network interface cards. Communications unit 310 may provide communications through the use of either or both physical and wireless communications links. Collaborative marketing promotion module 110 may be downloaded to persistent storage 308 through communications unit 310.

I/O interface(s) 312 allows for input and output of data with other devices that may be connected to computing device 102. For example, I/O interface 312 may provide a connection to external devices 318 such as a keyboard, keypad, a touch screen, and/or some other suitable input device. External devices 318 can also include portable computer readable storage media such as, for example, thumb drives, portable optical or magnetic disks, and memory cards. Software and data used to practice embodiments of the present invention, e.g., collaborative marketing promotion module 110 can be stored on such portable computer readable storage media and can be loaded onto persistent storage 308 via I/O interface(s) 312. I/O interface(s) 312 also connect to display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method comprising:
registering, by one or more processors, a user for a social IoT platform;
registering, by one or more processors, an IoT device associated with the registered user into the social IoT platform;
identifying by one or more processors, social contacts of the registered user in the social IoT platform;
detecting, by one or more processors, a plurality of IoT devices, in the social IoT platform, which are associated with the social contacts of the registered user;
monitoring, by one or more processors, the IoT device associated with the registered user and the plurality of IoT devices associated with the social contacts of the registered user;
analyzing, by one or more processors, social IoT feed among the IoT device associated with the registered user and the plurality of IoT devices associated with the social contacts of the registered user;
recognizing, by one or more processors, a collaborative need for a plurality of registered users based on the analysis of the social IoT feed; and
recommending, by one or more processors, a collaborative marketing plan based on the collaborative need for the plurality of registered users.

2. The computer-implemented method of claim 1, wherein monitoring the IoT device associated with the registered user and the plurality of IoT devices associated with the social contacts includes tracking the IoT device associated with the registered user and the plurality of IoT devices associated with the social contacts of the registered user.

3. The computer-implemented method of claim 1, wherein the social IoT feed includes interactions and conversations in the social IoT platform.

4. The computer-implemented method of claim 3, wherein analyzing the social IoT feed includes analyzing the interactions and conversations using natural language processing techniques.

5. The computer-implemented method of claim 3, wherein analyzing the social IoT feed includes analyzing the interactions and conversations using machine learning techniques.

6. The computer-implemented method of claim 1, wherein recognizing the collaborative need includes identifying two or more IoT devices in the social IoT platform that are correlated by a product.

7. The computer-implemented method of claim 1, wherein recommending the collaborative marketing plan includes providing promotion offerings, based on a marketing input from a vendor, for the plurality of registered users.

8. A computer program product comprising:
one or more computer readable storage media, and program instructions collectively stored on the one or more computer readable storage media, the program instructions comprising:
program instructions to register a user for a social IoT platform;
program instructions to register an IoT device associated with the registered user into the social IoT platform;
program instructions to identify social contacts of the registered user in the social IoT platform;
program instructions to detect a plurality of IoT devices, in the social IoT platform, which are associated with the social contacts of the registered user;
program instructions to monitor the IoT device associated with the registered user and the plurality of IoT devices associated with the social contacts of the registered user;
program instructions to analyze social IoT feed among the IoT device associated with the registered user and the plurality of IoT devices associated with the social contacts of the registered user;
program instructions to recognize a collaborative need for a plurality of registered users based on the analysis of the social IoT feed; and
program instructions to recommend a collaborative marketing plan based on the collaborative need for the plurality of registered users.

9. The computer program product of claim 8, wherein program instructions to monitor the IoT device associated with the registered user and the plurality of IoT devices associated with the social contacts include program instructions to track the IoT device associated with the registered user and the plurality of IoT devices associated with the social contacts of the registered user.

10. The computer program product of claim 8, wherein the social IoT feed includes interactions and conversations in the social IoT platform.

11. The computer program product of claim 10, wherein program instructions to analyze the social IoT feed include program instructions to analyze the interactions and conversations using natural language processing techniques.

12. The computer program product of claim 10, wherein program instructions to analyze the social IoT feed include program instructions to analyze the interactions and conversations using machine learning techniques.

13. The computer program product of claim 8, wherein program instructions to recognize the collaborative need include program instructions to identify two or more IoT devices in the social IoT platform that are correlated by a product.

14. The computer program product of claim 8, wherein program instructions to recommend the collaborative marketing plan include program instructions to provide promotion offerings, based on a marketing input from a vendor, for the plurality of registered users.

15. A computer system comprising:
one or more computer processors, one or more computer readable storage media, and program instructions stored on the one or more computer readable storage media for execution by at least one of the one or more computer processors, the program instructions comprising:
program instructions to register a user for a social IoT platform;
program instructions to register an IoT device associated with the registered user into the social IoT platform;
program instructions to identify social contacts of the registered user in the social IoT platform;
program instructions to detect a plurality of IoT devices, in the social IoT platform, which are associated with the social contacts of the registered user;
program instructions to monitor the IoT device associated with the registered user and the plurality of IoT devices associated with the social contacts of the registered user;
program instructions to analyze social IoT feed among the IoT device associated with the registered user and the plurality of IoT devices associated with the social contacts of the registered user;
program instructions to recognize a collaborative need for a plurality of registered users based on the analysis of the social IoT feed; and
program instructions to recommend a collaborative marketing plan based on the collaborative need for the plurality of registered users.

16. The computer system of claim 15, wherein program instructions to monitor the IoT device associated with the registered user and the plurality of IoT devices associated with the social contacts include program instructions to track the IoT device associated with the registered user and the plurality of IoT devices associated with the social contacts of the registered user.

17. The computer system of claim 15, wherein the social IoT feed includes interactions and conversations in the social IoT platform.

18. The computer system of claim 17, wherein program instructions to analyze the social IoT feed include program instructions to analyze the interactions and conversations using natural language processing techniques.

19. The computer system of claim 15, wherein program instructions to recommend the collaborative marketing plan include program instructions to provide promotion offerings, based on a marketing input from a vendor, for the plurality of registered users.

20. The computer system of claim 15, wherein program instructions to recommend the collaborative marketing plan include program instructions to consider location of the plurality of registered users.
